(19) United States
(12) Patent Application Publication
(10) Pub. No.: US 2011/0242091 A1
(43) Pub. Date: Oct. 6, 2011

(54) IMAGE PROCESSING CIRCUIT

(76) Inventors: Hitoshi Kobayashi, Kanagawa-ken (JP); Tatsuo Saishu, Tokyo (JP); Yoshiyuki Kokojima, Kanagawa-ken (JP)

(21) Appl. No.: 12/879,937

(22) Filed: Sep. 10, 2010

(30) Foreign Application Priority Data
Mar. 31, 2010 (JP) P2010-084323

(51) Int. Cl. G06T 15/00

(52) U.S. Cl. 345/419

(57) ABSTRACT

An image processing circuit includes a first memory, a second memory, a write unit and a read unit. The first and second memories alternately store sub pixels of an input image including a plurality of parallax images corresponding to different view point directions. The write unit writes the sub pixels to one of the first and second memories. The read unit reads the sub pixels as an output image from the other of the first and second memories. Each of the first and second memories stores sub pixels for a plurality of successive lines. While the write unit writes the sub pixels of the input image to one of the first and second memories, the read unit reads the sub pixels of the output image from the other of the first and second memories. The first and the second memories are alternately changed.

### CROSS-REFERENCE TO RELATED APPLICATION

This application is based upon and claims the benefit of priority from Japanese Patent Application No. 2010-084323, filed on Mar. 31, 2010, the entire contents of which are incorporated herein by reference.

### FIELD

Embodiments described herein relate generally to an image processing circuit.

### BACKGROUND

An image processing method exists for generating a stereoscopic image to be displayed on a parallax-barrier type stereoscopic image display device. The stereoscopic image is generated by rearranging and combining pixels of a connected image obtained by connecting multiple parallax images having different parallaxes.

An image processing method is disclosed in JP-A 2003-70022 (KOKAI). In this reference, a stereoscopic image is generated by rearranging, one by one, pixels of a connected image by software processing using a central processing unit (CPU).

Since the pixels of the connected image are rearranged one by one using software processing in the above image processing method, it may take long time to complete the image processing.

### BRIEF DESCRIPTION OF THE DRAWINGS

Aspects of this disclosure will become apparent upon reading the following detailed description and upon reference to the accompanying drawings. The description and the associated drawings are provided to illustrate embodiments of the invention and not limited to the scope of the invention.

FIG. 1 is a block diagram showing a configuration of an image processing circuit 1 according to a first embodiment;

FIG. 2A is a diagram for explaining the mechanism of a multi-parallax type stereoscopic image;

FIG. 2B is a diagram for explaining the mechanism of a multi-parallax type stereoscopic image;

FIG. 3 is a diagram showing the connected image 5 and the stereoscopic image 6;

FIG. 4 is a diagram for explaining processing of sub pixels by the image processing circuit 1;

FIG. 5 is a block diagram showing examples of the selector A103 of the first selector, the first memory 101 and the selector C105;

FIG. 6 is a diagram for describing the first MUX 103a of the selector A;

FIG. 7 is a diagram for describing the first DEMUX 105a in the selector C;

FIG. 8 is a diagram showing the write counter 110, the read counter 111, the write controller 107 and the read controller 108 in the image processing circuit 1;

FIG. 9 is a time chart for explaining processing of the image processing circuit 1;

FIG. 10 is a time chart for explaining processing of the image processing circuit 1;

FIG. 11 is a block diagram showing the write controller 107; and

FIG. 12 is a block diagram showing the read controller 108.

### DETAILED DESCRIPTION

According to one aspect of the invention, an image processing circuit includes a first memory and a second memory configured to alternately store sub pixels of an input image including a plurality of parallax images corresponding to different view point directions; a write unit configured to write the sub pixels of the input image to one of the first memory and the second memory; and a read unit configured to read the sub pixels as an output image from the other of the first memory and the second memory, wherein the first memory and the second memory stores sub pixels for a plurality of successive lines, the number of lines being equal to the number of color components in the parallax images included in the input image, and while the write unit writes the sub pixels for the plurality of lines of the input image to one of the first memory and the second memory, the read unit reads the sub pixels for the plurality of lines of the output image from the other of the first memory and the second memory, the first memory and the second memory being alternately changed.

The embodiments will be explained with reference to the accompanying drawings.

Note that, the same reference numbers are given to the same configuration and components in figures, and the description will be omitted.

### Description of the First Embodiment

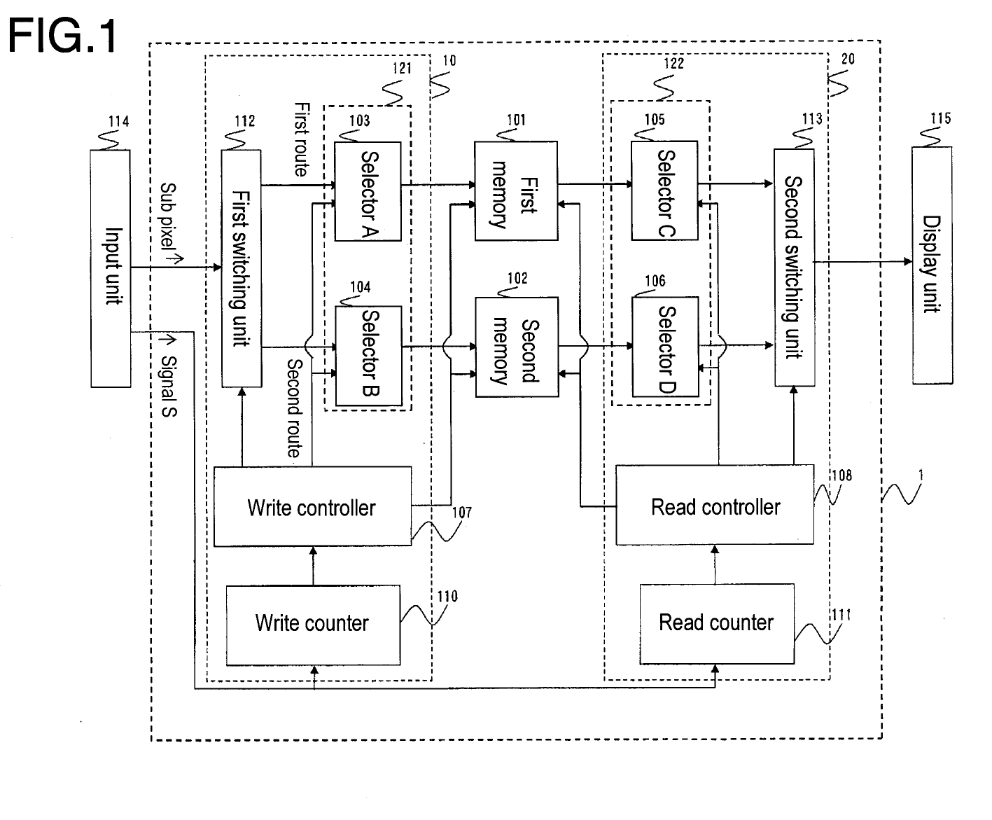

FIG. 1 is a block diagram of an image processing circuit 1 according to the first embodiment. The image processing circuit 1 changes the output order of sub pixels of a connected image 5 for stereoscopic image 6, which are inputted sequentially from an input unit 114. Then, the image processing circuit 1 outputs the sub pixels to a display unit 115, so that the sub pixels are displayed as the stereoscopic image 6. The image processing circuit 1 can be used to generate the stereoscopic image 6 to be displayed on a multi-parallax type stereoscopic image display device, for example.

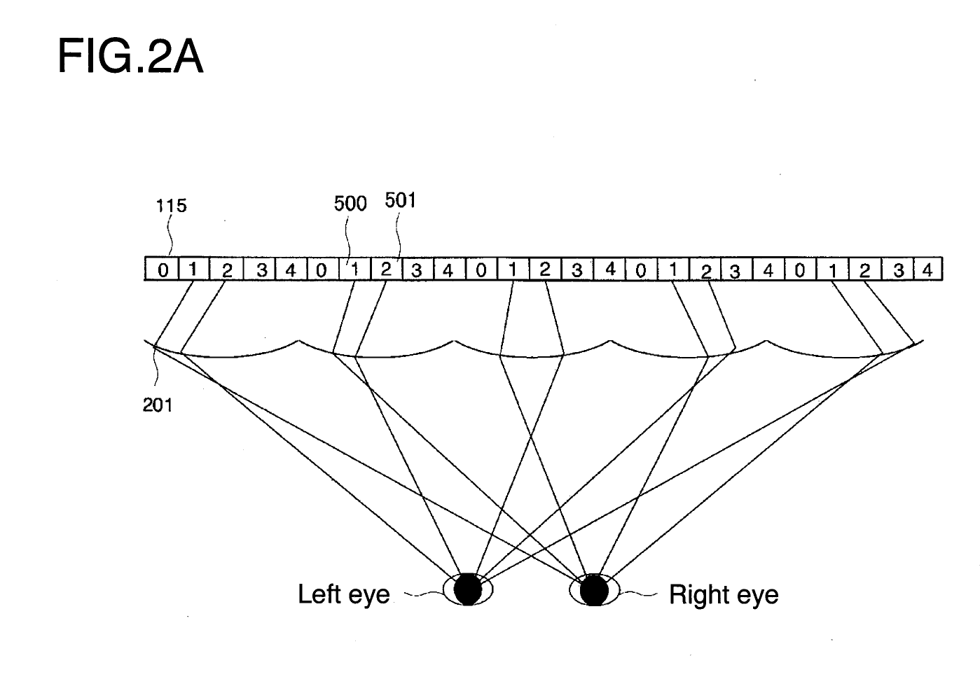

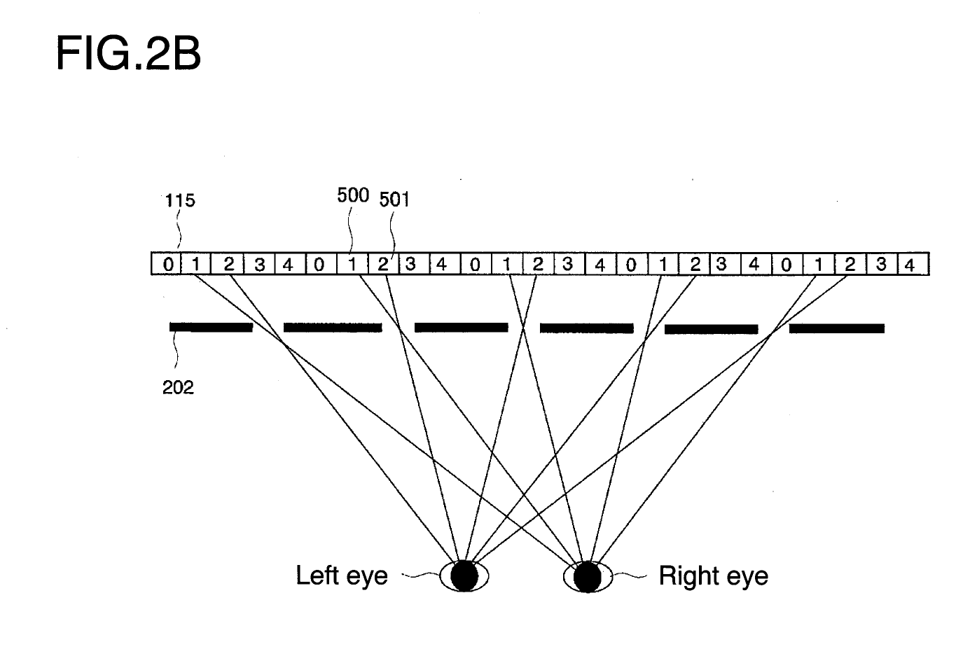

FIGS. 2A and 2B are diagrams showing the mechanism of a multi-parallax type stereoscopic image display device. A multi-parallax type stereoscopic image display device is a stereoscopic image display device in which the stereoscopic image 6 is displayed on the display unit 115, and a beam control element is placed in front of the display unit 115 to control the orientation of light beams emitted from the display unit 115. Thus, a viewer is allowed to perceive the stereoscopic image 6. Examples of the multi-parallax system include the lenticular system in which a lenticular sheet 201 is used as the beam control element, and the parallax barrier system in which a light-shielding barrier 202 is used as the beam control element.

In the first embodiment, pixels each including sub pixels of three colors of red (R), green (G) and blue (B) are arranged in a first direction and a second direction in a matrix. For example, the first direction is a direction that follows an address line of the display unit 115. The second direction is a direction that follows a data line of the display unit 115.

FIG. 2A is a view of the lenticular-stereoscopic image display device as viewed in the second direction. In the lenticular-stereoscopic image display device, the lenticular sheet 201 is placed so as to face the display unit 115 on which the stereoscopic image 6 is displayed. Light beams emitted from the display unit 115 are refracted to have orientations different from one another by the lenticular sheet 201, and pass through the lenticular sheet 201.

If the viewer views the display unit 115 from a certain view point, he/she perceives, by one eye, light beams emitted from multiple sub pixels 500 assigned the number “1,” and perceives, by the other eye, light beams emitted from multiple sub pixels 501 assigned the number “2.” In FIG. 2A, the viewer's right eye sees the multiple sub pixels 500 assigned the number “1,” and his/her left eye sees the multiple sub pixels 501 assigned the number “2.”

A group of sub pixels assigned the same number shows a parallax image seen from a certain parallax direction. To be specific, a group of multiple sub pixels 500 assigned the number “1” is a parallax image seen from one parallax direction. A group of multiple sub pixels 501 assigned the number “2” is a parallax image seen from another parallax direction. The viewer perceives the stereoscopic image 6 by seeing a different parallax image with each eye.

FIG. 2B is a view of the parallax-barrier stereoscopic image display device as viewed in the second direction. In the parallax-barrier stereoscopic image display device, the light-shielding barrier 202 is placed so as to face the display unit 115 on which the stereoscopic image 6 is displayed. The light-shielding barrier 202 shields some of light beams emitted from the display unit 115, so that only light beams emitted from specific multiple sub pixels 500 are allowed to pass through.

If the viewer views the display unit 115 from a certain view point, he/she perceives, by one eye, light beams emitted from multiple sub pixels 500 assigned the number “1,” and perceives, by the other eye, light beams emitted from multiple sub pixels 501 assigned the number “2.” In FIG. 2B, the viewer's right eye sees the multiple sub pixels 500 assigned the number “1,” and his/her left eye sees the multiple sub pixels 501 assigned the number “2.” The viewer perceives the stereoscopic image 6 by seeing a different parallax image with each eye.

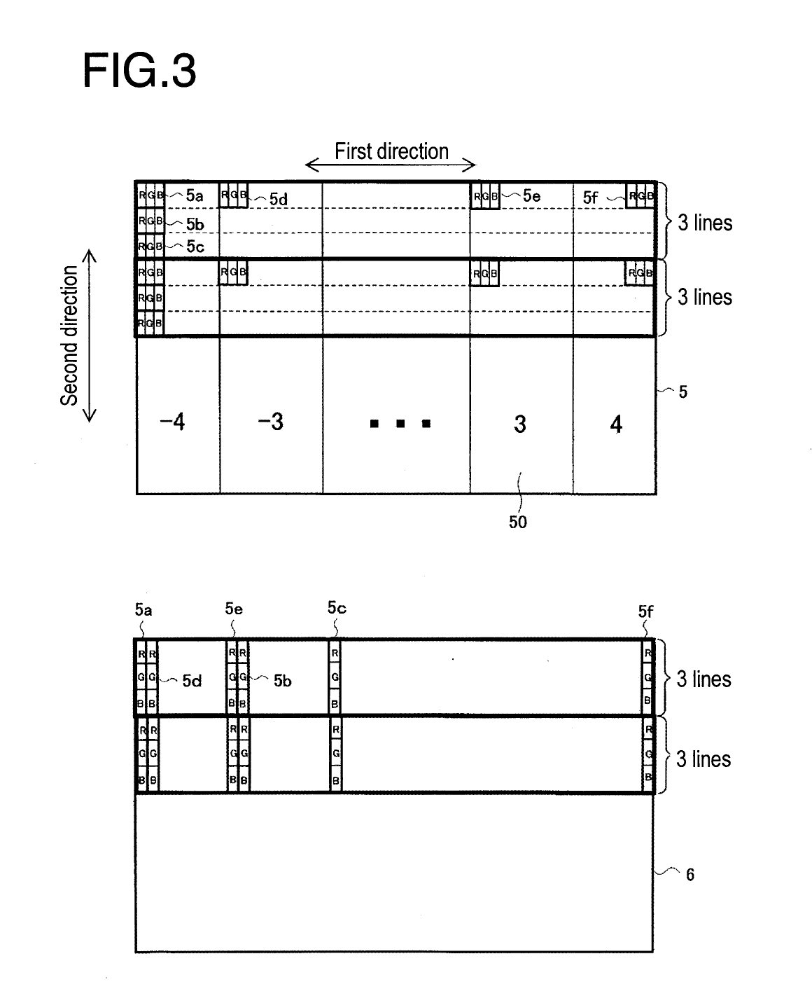

FIG. 3 shows the connected image 5 and the stereoscopic image 6. The connected image 5 is an image in which multiple parallax images 50 are connected along the first direction. The connected image 5 includes multiple sub pixels. For example, in the connected image 5, the parallax images 50 for nine parallaxes ranging from parallax number −4 to 4 are connected along the first direction. In FIG. 3, the numbers assigned to the parallax images 50 indicate the parallax numbers, respectively.

The stereoscopic image 6 is an image in which sub pixels of the parallax images 50 are arranged so as to allow the viewer to see one parallax image 50 with one eye and see the other parallax image 50 with the other eye when he/she views the display unit 115 through a beam control element from a certain view point.

The stereoscopic image 6 is generated by rearranging sub pixels of the connected image 5. Specific rearranging methods are described in Japanese Patent No. 4202991.

In the first embodiment, two adjacent pixels in each of the parallax images 50 included in the connected image 5 are arranged so as to be separated along the first direction for the number of sub pixels corresponding to the number of parallaxes, in the stereoscopic image 6.

For example, in FIG. 3, pixels 5a and 5b which are adjacent to each other in the second direction in the parallax-number “−4” portion of the connected image 5 are in turn, arranged so that sub pixels of the pixels 5a and 5b are separated for the number of parallaxes along the first direction in the stereoscopic image 6. Pixels 5b and 5c which are adjacent to each other in the second direction are similarly arranged, so that sub pixels of the pixels 5b and 5c are separated for the number of parallaxes along the first direction in the stereoscopic image 6. A pixel 5d in the parallax-number “−3” portion of the connected image 5 is arranged adjacent to the pixel 5a of the parallax number “−4” in the first direction in the stereoscopic image 6.

Thus, the stereoscopic image 6 is generated by rearranging positions of sub pixels in the connected image 5.

In addition, when the viewer views the display unit 115 through a beam control element from a certain view point direction, he/she cannot see multiple sub pixels, which are adjacent to each other in the first direction, all at once. Accordingly, in the stereoscopic image 6, red (R), green (G) and blue (B) sub pixels constituting a pixel in the connected image 5 are also rearranged so as to be adjacent to each other in the second direction instead of the first direction.

In other words, the stereoscopic image 6 is generated by rearranging sub pixels within sub pixels for every three lines, starting from the first line of the connected image 5.

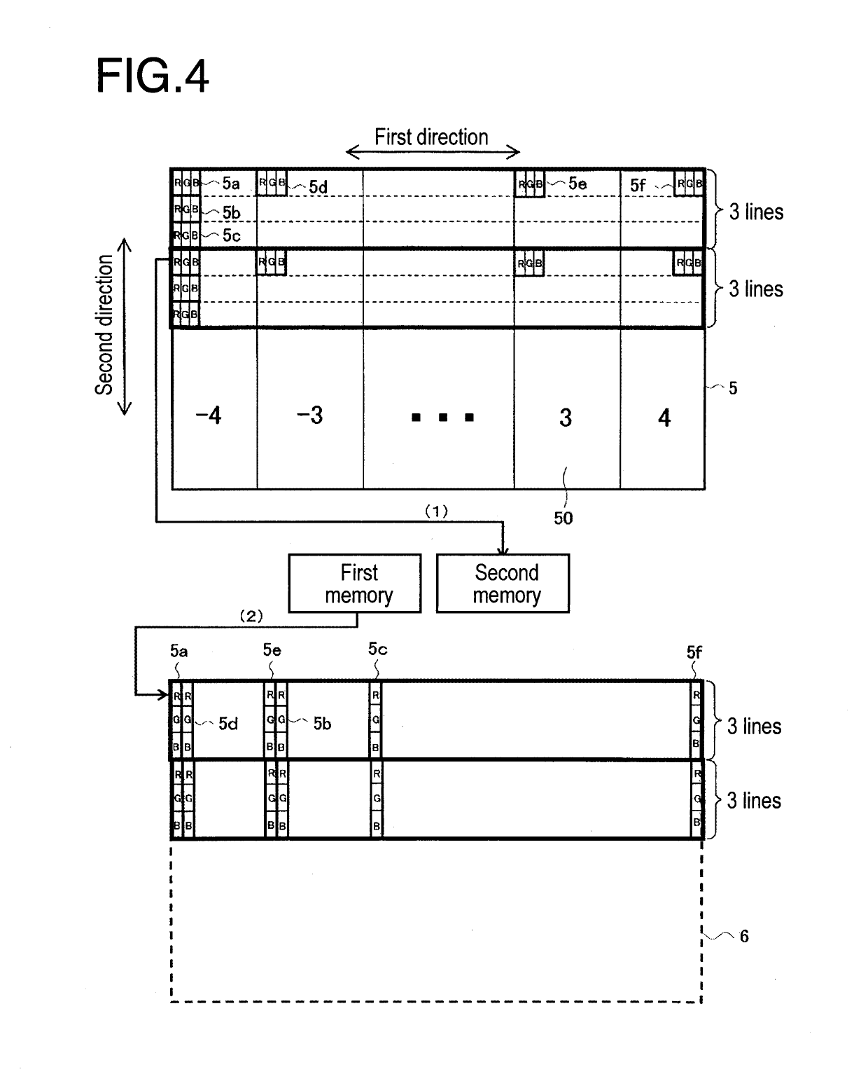

FIG. 4 is a conceptual diagram showing processing of sub pixels by the image processing circuit 1. The image processing circuit 1 includes at least two memories (first memory 101 and second memory 102). Other portions of the configuration are described later.

The image processing circuit 1 writes sub pixels for three lines, which are sequentially inputted from the input unit 114, to one of the first memory 101 and the second memory 102 by designating an address. Then, the image processing circuit 1 writes sub pixels for the next three lines to the other one of the first memory 101 and the second memory 102 by designating an address.

While writing the sub pixels to one of the first memory 101 and the second memory 102, the image processing circuit 1 reads, by designating addresses in an output sequence, sub pixels written in the other one of the first memory 101 and the second memory 102, and outputs the read sub pixels on the display unit 115.

The image processing circuit 1 alternately repeats the above processing.

For example, in FIG. 4, while writing the second set of sub pixels for three lines to the second memory 102 (processing (1)), the image processing circuit 1 reads the first set of sub pixels for three lines written to the first memory 101 in advance (processing (2)).

Thus, the inputted connected image 5 is displayed on the display unit 115 as the stereoscopic image 6.

In addition to the first memory 101 and the second memory 102, the image processing circuit 1 further includes a write unit 10 and a read unit 20.

The write unit 10 includes a first switching unit 112, a first selector 121, a write controller 107 and a write counter 110. The read unit 20 includes a second selector 122, a second switching unit 113, a read controller 108 and a read counter 111. The first selector 121 includes a selector A103 and a selector B104. The second selector 122 includes a selector C105 and a selector D106.

The first memory 101 stores sub pixels for every three lines of the connected image 5. The second memory 102 stores the next set of sub pixels for three lines of the connected image 5.

Hence, the read unit 20 can read sub pixels from the second memory 102 while the write unit 10 writes sub pixels to the first memory 101.

The input unit 114 supplies sub pixels of the connected image 5 to the first switching unit 112. The input unit 114 also supplies a signal S to the write counter 110 and to the read counter 111. The signal S is a signal supplied to generate a write signal WRC and a read signal RDC. The write signal WRC is used by the write counter 110 to operate the write controller 107, and the read signal RDC is used by the read counter 111 to operate the read controller 108.

The write counter 110 generates the write signal WRC on the basis of the signal S. The write controller 107 controls, in accordance with the write signal WRC, the first switching unit 112, the first selector 121 and one of the first memory 101 and the second memory 102. In addition, the write controller 107 writes sub pixels to a predetermined address of the first memory 101 or the second memory 102.

The read counter 111 generates the read signal RDC on the basis of the signal S. The read controller 108 controls, in accordance with the read signal RDC, the second switching unit 113, the second selector 122 and one of the first memory 101 and the second memory 102. In addition, the read controller 108 reads sub pixels from a predetermined address of the first memory 101 or the second memory 102.

The first switching unit 112 switches, according to control performed by the write controller 107, routes (a first route directed to the first memory 101 or a second route directed to the second memory 102) for sub pixels of the connected image 5.

If the first memory 101 includes multiple memory elements, the selector A103 connects a route to a certain memory element for certain sub pixels, according to control performed by the write controller 107. If the second memory 102 includes multiple memory elements, the selector B104 connects a route to a certain memory element for certain sub pixels, according to control performed by the write controller 107.

The memory element may be SRAM.

If the first memory 101 includes multiple memory elements, the selector C105 connects a route to a certain memory element for certain sub pixels, according to control performed by the read controller 108. If the second memory 102 includes multiple memory elements, the selector D106 connects a route to a certain memory element for certain sub pixels, according to control performed by the read controller 108.

The second switching unit 113 switches, according to control performed by the read controller 108, routes (route directed from the first memory 101 or route directed from the second memory 102) for sub pixels to be outputted on the display unit 115 as the stereoscopic image 6.

Hereinafter, we will explain detail of the first embodiment.

In the first embodiment, an exemplar case is considered in which the stereoscopic image 6 is generated by rearranging sub pixels of the connected image 5 including 4200 sub pixels (1400 pixels) in the first direction, and 1050 sub pixels in the second direction.

The connected image 5 includes multiple pixels. Each pixel includes sub pixel data of sub pixels for respective color components. The input unit 114 supplies the sub pixel data to the first switching unit 112. The input unit 114 supplies the signal S to the write counter 110 and to the read counter 111. The signal S includes a clock signal CLK, a vertical synchronization signal VSYNC, a horizontal synchronization signal HSYNC and a data enable signal DE.

The write counter 110 outputs, to the write controller 107, the write signal WRC based on the clock signal CLK, the vertical synchronization signal VSYNC, the horizontal synchronization signal HSYNC and the data enable signal DE. The read counter 111 outputs, to the read controller 108, the read signal RDC based on the clock signal CLK, the vertical synchronization signal VSYNC, the horizontal synchronization signal HSYNC and the data enable signal DE. The signals are described later.

The sub pixels are normally supplied from the input unit 114 in an order starting from the topmost line of the connected image 5 toward the lower portion of the image. Within a single line, the order of supplying the sub pixels is from left to right in the connected image 5 in FIG. 4.

The first switching unit 112 switches, according to control performed by the write controller 107, routes (first route or second route) for sub pixels sequentially inputted from the input unit 114. The first switching unit 112 may be a 2-to-1 multiplexer (MUX) (not shown), for example. In the first embodiment, the first switching unit 112 is controlled by the write controller 107. The first switching unit 112 alternately switches the routes for sequentially-inputted sub pixels at every three lines. Thus, the sub pixels of the connected image 5 are alternately directed to the first route and the second route at every three lines. For example, sub pixels for the first to third lines of the connected image 5 are forwarded through the first route. Meanwhile, sub pixels for the fourth to sixth lines of the connected image 5 are forwarded through the second route. Then, sub pixels for the seventh to ninth lines of the connected image 5 are forwarded through the first route.

A description is given of the selector A103, the first memory 101 and the selector C105 included in the first route. Operations of the selector B104, the second memory 102 and the selector D106 included in the second route are the same as those of the selector A103, the first memory 101 and the selector C105, and thus description is skipped.

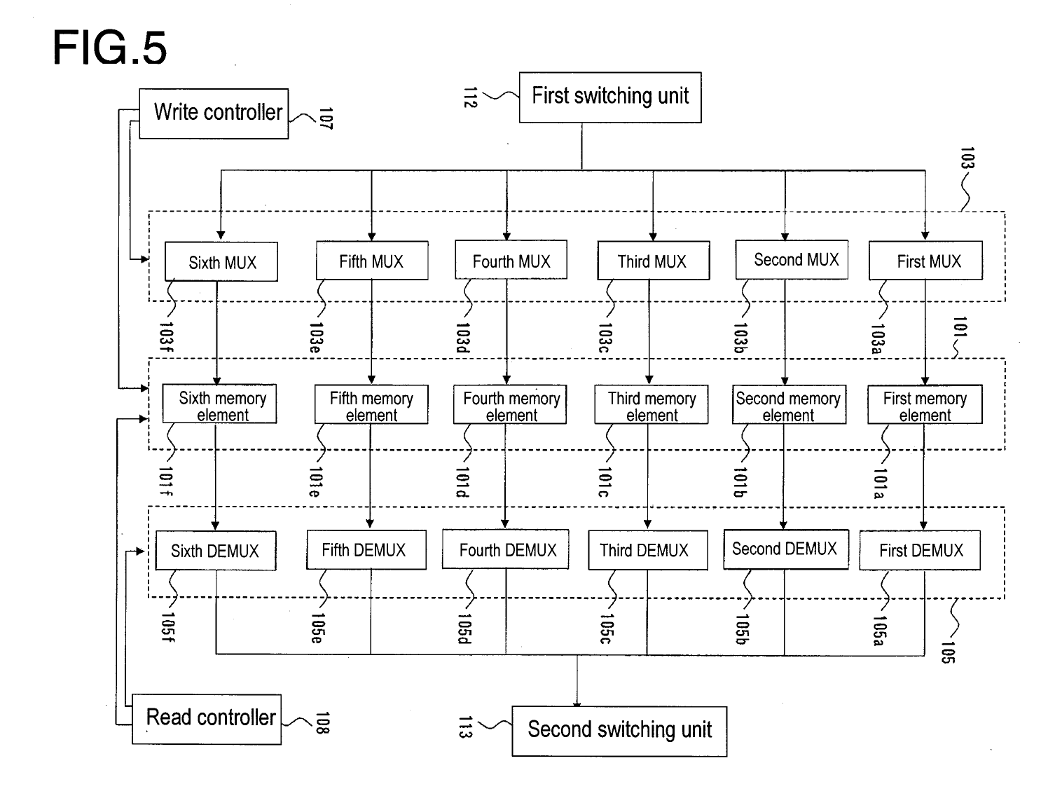

FIG. 5 is a block diagram showing concrete examples of the selector A103 of the first selector, the first memory 101 and the selector C105. The first memory 101 includes multiple memory elements. In the first embodiment, the first memory 101 includes six memory elements (first memory element 101a, second memory element 101b, third memory element 101c, fourth memory element 101d, fifth memory element 101e and sixth memory element 1010 in parallel. The capacities of the memories may be the same.

Although there are six of the memory elements in the first embodiment, the number of memory elements is not limited to six. That is, it suffices that the first memory 101 has a capacity to store sub pixels for three lines. A description is given later of the capacity of the memory element.

The selector A103 includes the same number of multiplexers (MUX) as the memory elements included in the first memory 101. The selector A103 includes a first MUX 103a, a second MUX 103b, a third MUX 103c, a fourth MUX 103d, a fifth MUX 103e and a sixth MUX 103f. Each MUX is connected to a memory element on a one-to-one basis.

The selector C105 includes the same number of demultiplexers (DEMUX) as the memory elements included in the first memory 101. The selector C105 includes a first DEMUX 105a, a second DEMUX 105b, a third DEMUX 105c, a fourth DEMUX 105d, a fifth DEMUX 105e and a sixth DEMUX 105f. Each DEMUX is connected to a memory element on a one-to-one basis.

Each MUX is connected to the write controller 107, and each DEMUX is connected to the read controller 108. Each memory element is connected to the write controller 107 and the read controller 108.

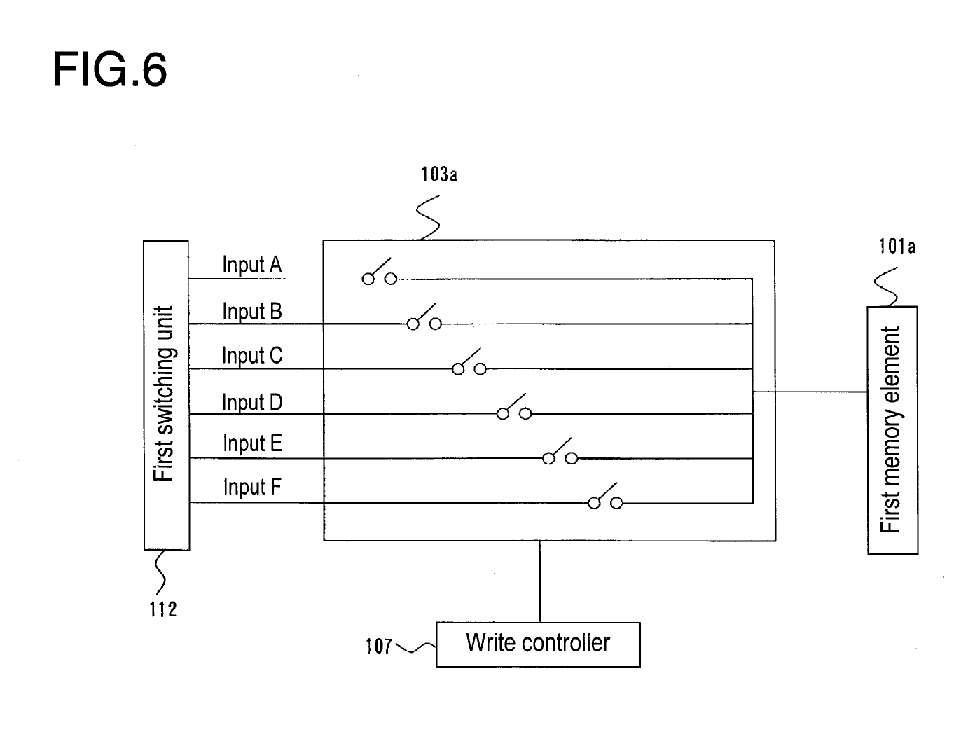

The MUX in the selector A is described. In the first embodiment, a 6-to-1 MUX is employed. FIG. 6 is a diagram for describing the first MUX 103a of the selector A. Other MUXs have the same configuration as the first MUX 103a.

Sub pixels are inputted to inputs (inputs A to F) of the first MUX 103a in the order that the sub pixels are inputted from the input unit 114. For example, a sub pixel (R, 1, 1) is inputted to input A. A sub pixel (G, 1, 1) is inputted to input B. A sub pixel (B, 1, 1) is inputted to input C. A sub pixel (R, 1, 2) is inputted to input D. A sub pixel (G, 1, 2) is inputted to input E. A sub pixel (B, 1, 2) is inputted to input F.

(R, 1, 1) indicates a sub pixel R in the first row of the first line in the connected image 5. (G, 1, 1) indicates a sub pixel G in the first row of the first line in the connected image 5. (B, 1, 1) indicates a sub pixel B in the first row of the first line in the connected image 5. (R, 1, 2) indicates a sub pixel R in the second row of the first line in the connected image 5. (G, 1, 2) indicates a sub pixel G in the second row of the first line in the connected image 5. (B, 1, 2) indicates a sub pixel B in the second row of the first line in the connected image 5.

Sub pixels are inputted in a similar manner in each of the second MUX 105b to the sixth MUX 105f.

In the first embodiment, the selector A103 includes six MUXs. Thus, when each MUX selects a different input (inputs A to F) according to control performed by the write controller 107, six sub pixels can be transmitted collectively to the first memory 101.

The first MUX 103a transmits the sub pixel (R, 1, 1) to the first memory element 101a. The second MUX 103b transmits the sub pixel (G, 1, 1) to the second memory element 101b. The third MUX 103c transmits the sub pixel (B, 1, 1) to the third memory element 101c. The fourth MUX 103d transmits the sub pixel (R, 1, 2) to the fourth memory element 101d. The fifth MUX 103e transmits the sub pixel (G, 1, 2) to the fifth memory element 101e. The sixth MUX 103f transmits the sub pixel (B, 1, 2) to the sixth memory element 101f.

In the first embodiment, image data for three lines of the connected image 5 is stored to the first memory 101 while image data for three lines is read from the second memory 102, the connected image including 4200 sub pixels (1400 pixels) in the horizontal direction. Then, image data for three lines of the connected image 5 is stored to the second memory 102 while image data for three lines is read from the first memory 101. The operations are repeated alternately. In addition, the first memory 101 and the second memory 102 each include six memory elements. Hence, an address ADR for a certain memory element needs to satisfy ADR>12600 (4200×3/6). Accordingly, an address ADR required for a certain memory element is at least 12 bits. Since the data width of each sub pixel in the first embodiment is 6 bits (64 shades), the capacity needed for a memory element is 24576 (2̂ 12×6) bits. (2̂ 12) indicates 2 to the 12th power.

The memory element stores sub pixels transmitted from the connected MUX to an address designated by the write controller 107.

The write controller 107 determines an address to which sub pixels sequentially inputted from the input unit 114 should be stored. The memory element outputs sub pixels stored in an address designated by the read controller 108 to the connected DEMUX.

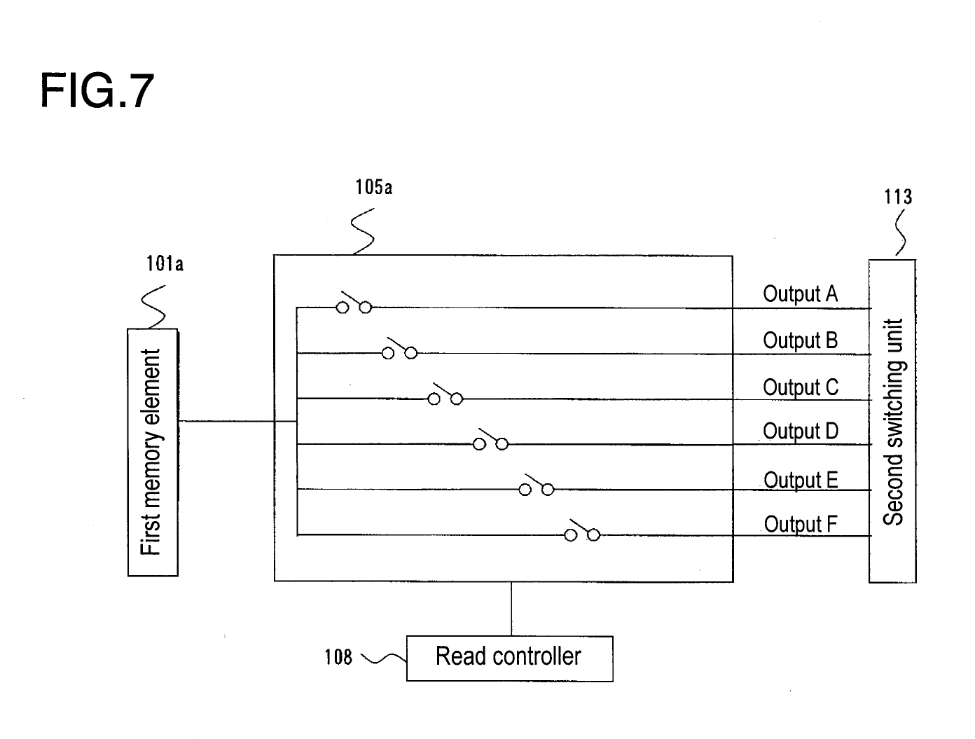

In the first embodiment, a 1-to-6 DEMUX is employed. FIG. 7 is a diagram for describing the first DEMUX 105a in the selector C. Different sub pixels are outputted from other outputs (outputs A to F) according to control performed by the read controller 108.

The read controller 108 controls the order of outputting the different sub pixels to the display unit 115, the different sub pixels being outputted from the memory elements to the respective DEMUXs. For example, the different sub pixels may be outputted to the display unit 115 in an order of output A, output B, output C, output D, output E, and output F.

Hereinabove, a description has been given of the selector A103, the first memory 101 and the selector C105 provided in the first route. The selector B104, the second memory 102 and the selector D106 provided in the second route operate in the same manner.

The second switching unit 113 switches, according to control performed by the read controller 108, routes (first route or second route) of the sub pixels to be outputted to the display unit 115. The second switching unit 113 may be a 1-to-2 demultiplexer (DEMUX) (not shown).

The second switching unit 113 is controlled by the read controller 108 so as to output the sub pixels to the display unit 115 via a route different from that selected by the first switching unit 112. For example, the first switching unit 112 selects the first route according to control performed by the write controller 107 and writes the sub pixels to the first memory 101. Meanwhile, the second switching unit 113 selects the second route according to control performed by the read controller 108 and displays the sub pixels read from the second memory 102 on the display unit 115.

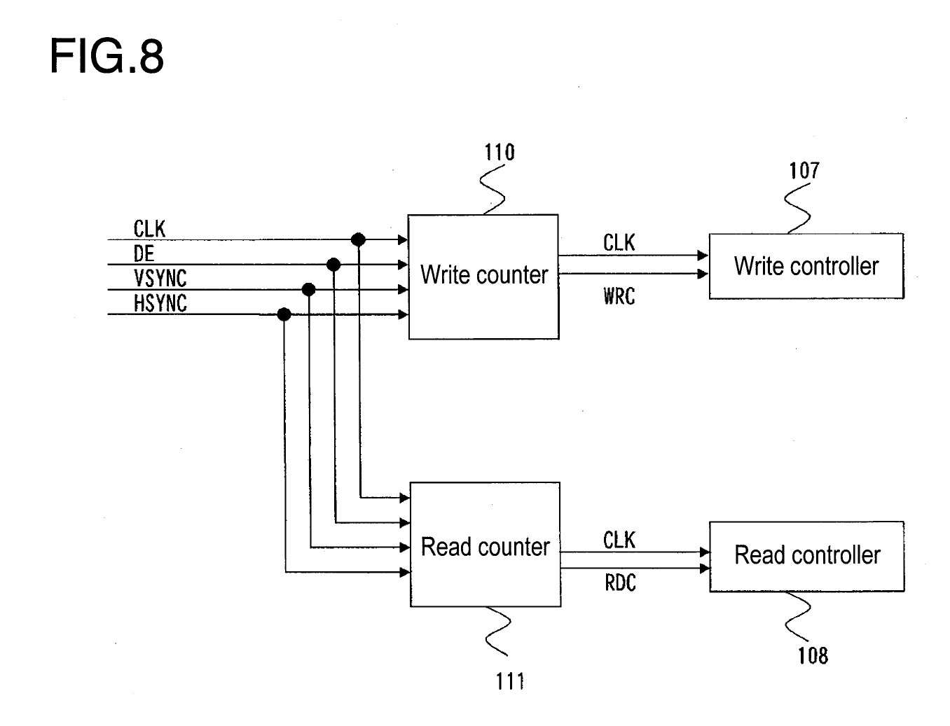

FIG. 8 is a block diagram showing the write counter 110, the read counter 111, the write controller 107 and the read controller 108. The write counter 110 generates the write signal WRC by use of the clock signal CLK, the vertical synchronization signal VSYNC, the horizontal synchronization signal HSYNC and the data enable signal DE which are included in the signal S.

The read counter 111 generates the read signal RDC by use of the clock signal CLK, the vertical synchronization signal VSYNC, the horizontal synchronization signal HSYNC and the data enable signal DE which are included in the signal S.

The write signal WRC includes a first count signal and a second count signal. The read signal RDC includes a third count signal and a fourth count signal.

The write controller 107 uses the first count signal to write a single sub pixel. The write controller 107 uses the second count signal to write sub pixels for three lines. The read controller 108 uses the third count signal to read a single sub pixel. The read controller 108 uses the fourth count signal to read sub pixels for three lines.

The write counter 110 outputs the clock signal CLK and the write signal WRC to the write controller 107. The read counter 111 outputs the clock signal CLK and the read signal RDC to the read controller 108.

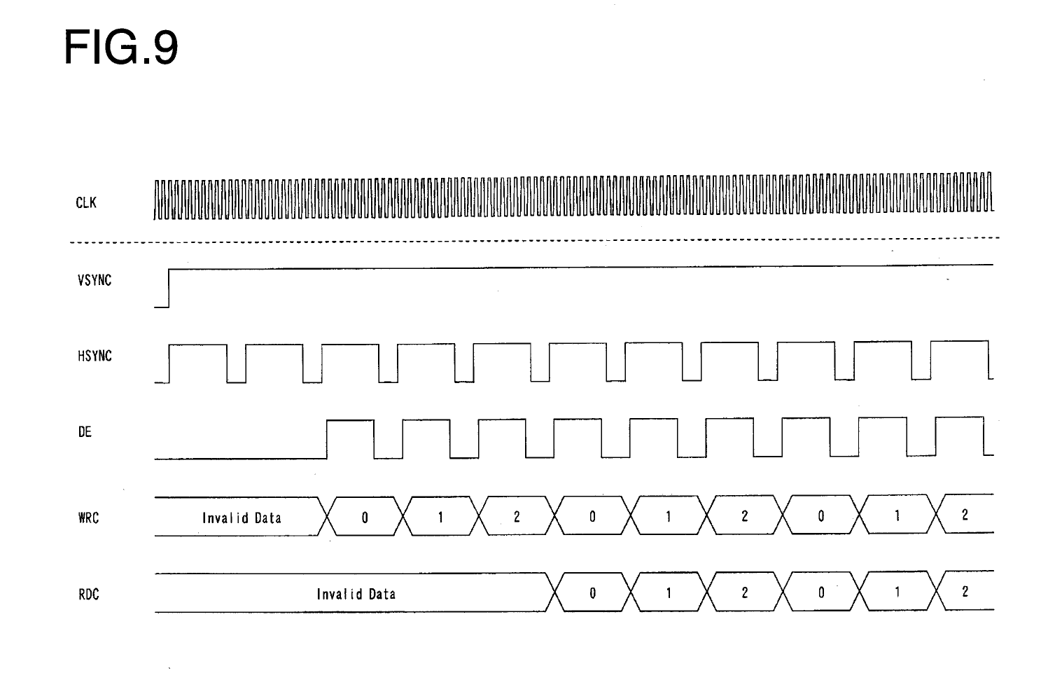

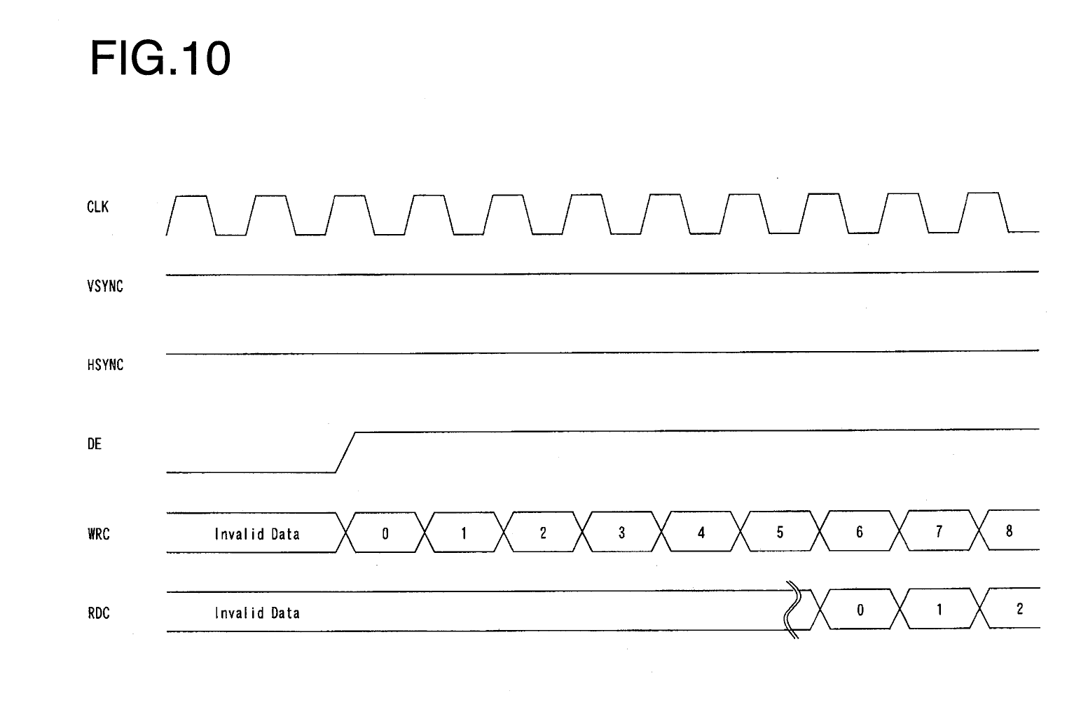

FIGS. 9 and 10 are diagrams showing time charts of the write counter 110 and the read counter 111, respectively. Note that the time scale of the clock signal CLK in FIG. 9 is different from time scales of other signals.

The data enable signal DE rises during the HIGH period of the horizontal synchronization signal HSYNC, and drops during the HIGH period of the horizontal synchronization signal HSYNC.

The write counter 110 generates the second count signal which corresponds to a count value of the number of rises in the data enable signal DE. The write counter 110 generates the first count signal which corresponds to a count value of the number of rises in the clock (CLK) during the HIGH period of the data enable signal DE.

The read counter 111 generates the third count signal which corresponds to a count value of the number of rises in the data enable signal DE. The read counter 111 generates the fourth count signal which corresponds to a count value of the number of rises in the clock (CLK) during the HIGH period of the data enable signal DE.

The first count signal and the third count signal count three HIGH periods of the data enable signal DE (repetition of 0, 1 and 2). Moreover, since 4200 sub pixels are included in a single line, the third count signal and the fourth count signal can be counted up to 4200.

In addition, the read signal RDC is outputted so as to be three data enable signals DE slower than the write signal WRC.

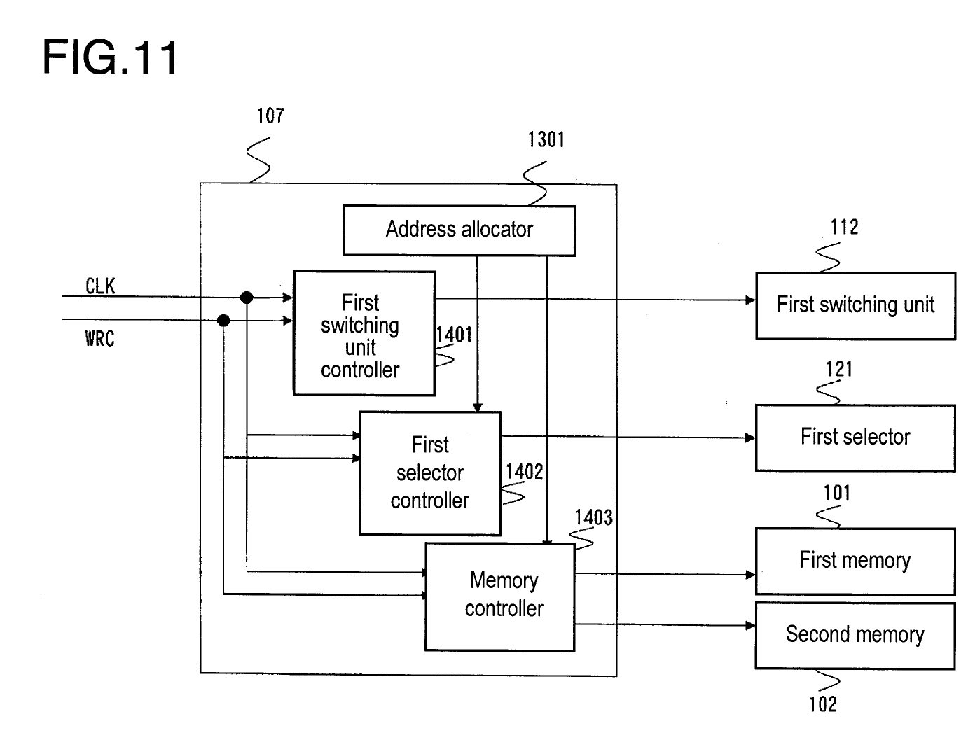

FIG. 11 is a block diagram showing the write controller 107. The write controller 107 includes a first switching unit controller 1401, a first selector controller 1402, a memory controller 1403 and an address allocator 1301.

The address allocator 1301 designates an address of a memory element in the first memory 101 or the second memory 102 to which the sub pixels sequentially inputted from the input unit 114 should be written. For example, the address allocator 1301 may be a look-up table indicating positions to which the sub pixels should be written. Here, the address allocator 1301 holds, as a table, previously-computed addresses to which the respective sub pixels should be written.

The first switching unit controller 1401 switches the first switching unit 112 every time the first count signal is reset.

The first selector controller 1402 controls each of the MUXs in the selector A103 and the selector B104 in the first selector 121 by use of the second count signal and the address allocator 1301.

The memory controller 1403 writes sub pixels to an address of the memory element of the first memory 101 or the second memory 102 by use of the second count signal and the address allocator 1301.

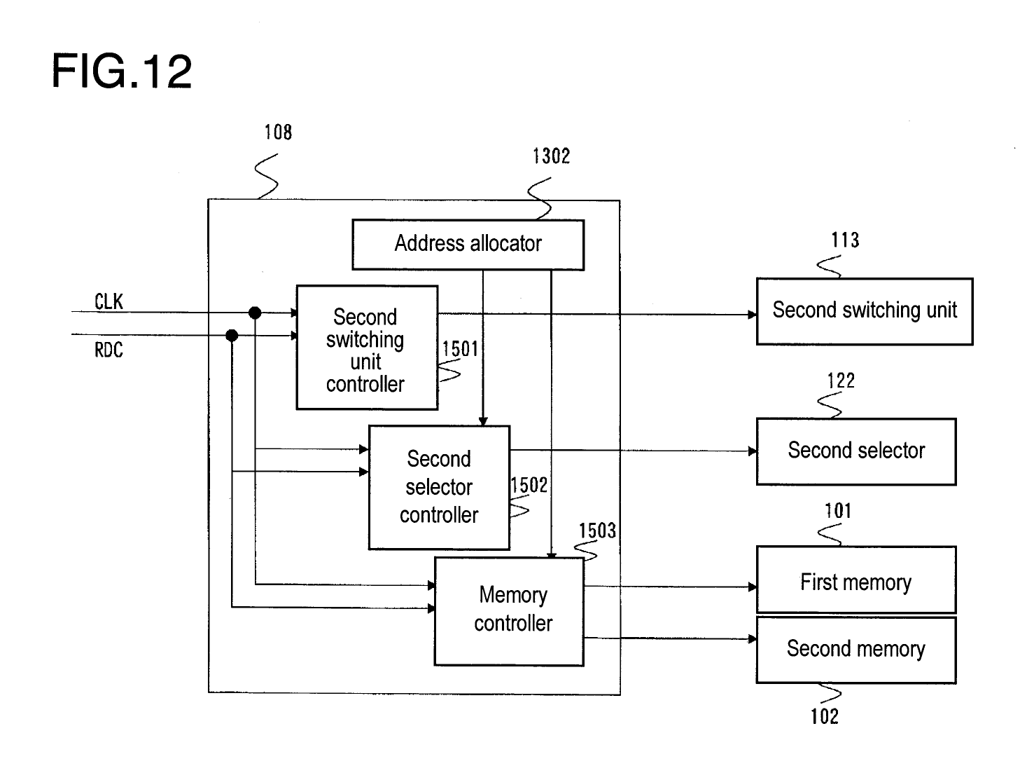

FIG. 12 is a block diagram showing the read controller 108. The read controller 108 includes a second switching unit controller 1501, a second selector controller 1502, a memory controller 1503 and an address allocator 1302.

The address allocator 1302 designates an address of a memory element in the first memory 101 or the second memory 102, from which the sub pixels to be outputted to the display unit 115 should be read. The address allocator 1302 may be a look-up table indicating positions from which the sub pixels should be read. Here, the address allocator 1302 holds, as a table, previously-computed addresses from which the respective sub pixels should be read.

The second switching unit controller 1501 switches the second switching unit 113 every time the third count signal is reset.

The second selector controller 1502 controls each of the MUXs in the selector C105 and the selector D106 in the second selector 122 by use of the fourth count signal and the address allocator 1302.

The memory controller 1503 reads sub pixels from an address of the memory element of the first memory 101 or the second memory 102 by use of the fourth count signal and the address allocator 1302.

Incidentally, the address allocators 1301 and 1302 may be provided in a form other than the look-up table. For example, the address allocators 1301 and 1302 may have a function of computing, on the basis of the specification of the display unit 115, addresses to which the sub pixels should be written or from which the sub pixels should be read.

In the first embodiment, the write unit 10 writes inputted sub pixels to the first memory 101 or the second memory 102 according to the address allocator 1301. Meanwhile, the read unit 20 reads outputted sub pixels according to the address allocator 1302. Thus, the stereoscopic image 6 is generated from the connected image 5.

In the first embodiment, the write controller 107 may exclusively perform random access to write the sub pixels to the first memory 101 or the second memory 102. Meanwhile, the read controller 108 may sequentially (such as in descending order starting from the first address in the first memory element 101a) read the written sub pixels and then output the sub pixels to the display unit 115. Here, the rearrangement table 1302 of the read controller 108 is unnecessary, and thus the circuit configuration can be made simpler.

Alternatively, the write controller 107 may sequentially (such as in descending order starting from the first address in the first memory element 101a) write the sub pixels in the same order as were inputted from the input unit 114. Meanwhile, the read controller 108 may exclusively perform random access to read the sub pixels from the first memory 101 or the second memory 102, and then output the sub pixels to the display unit 115. Here, the rearrangement table 1301 of the write controller 107 is unnecessary, and thus the circuit configuration can be made simpler.

According to the first embodiment, an image can be rearranged at a high speed by hardware processing.

While certain embodiments have been described, these embodiments have been presented by way of example only, and are not intended to limit the scope of the inventions. Indeed, the novel systems described herein may be embodied in a variety of other forms; furthermore, various omissions, substitutions and changes in the form of the methods and systems described herein may be made without departing from the sprit of the inventions. The accompanying claims and their equivalents are intended to cover such forms or modifications as would fall within the scope and spirit of the inventions.

What is claimed is:

1. An image processing circuit, comprising:
a first memory and a second memory configured to alternately store sub pixels of an input image including a plurality of parallax images corresponding to different view point directions;
a write unit configured to write the sub pixels of the input image to one of the first memory and the second memory; and
a read unit configured to read the sub pixels as an output image from the other of the first memory and the second memory, wherein
the first memory and the second memory stores sub pixels for a plurality of successive lines, the number of lines being equal to the number of color components in the parallax images included in the input image, and
while the write unit writes the sub pixels for the plurality of lines of the input image to one of the first memory and the second memory, the read unit reads the sub pixels for the plurality of lines of the output image from the other of the first memory and the second memory, the first memory and the second memory being alternately changed.

2. The circuit of claim 1, further comprising an address allocator configured to designate the address,
wherein
the write unit determines an address in one of the first memory and the second memory to which the sub pixels are written, with reference to the address allocator, and writes the sub pixels to the determined address.

3. The circuit of claim 1, further comprising an address allocator configured to designate the address, and
wherein
the read unit determines an address in one of the first memory and the second memory from which the sub pixels are read, with reference to the address allocator and reads the sub pixels from the determined address.

4. The circuit of claim 2, wherein
each of the first memory and the second memory includes a plurality of memory elements,
the write unit further comprises:
a first switching unit configured to switch a destination to which the sub pixels of the input image are written between the first memory and the second memory;
a first selector configured to select a memory element from among the plurality of memory elements; and
a write controller configured to control the first switching unit and the first selector so that the sub pixels are written to the address designated by the address allocator.

5. The circuit of claim 3, wherein
each of the first memory and the second memory includes a plurality of memory elements,
the read unit further comprises:
a second switching unit configured to switch a source from which the sub pixels of the output image are read between the first memory and the second memory;
a second selector configured to select a memory element from among the plurality of memory elements; and
a read controller configured to control the second switching unit and the second selector so that the sub pixels are read from the address designated by the address allocator.

6. The circuit of claim 4, wherein
color components in the parallax image comprise three components of red (R), green (G) and blue (B), and
the first switching unit, the first selector, the second switching unit and the second selector include one or a plurality of multiplexers.

7. The circuit of claim 5, wherein
color components in the parallax image comprise three components of red (R), green (G) and blue (B), and
the first switching unit, the first selector, the second switching unit and the second selector include one or a plurality of multiplexers.

8. An image processing method using a first memory and a second memory to alternately store sub pixels of an input image including a plurality of parallax images corresponding to different view point directions, comprising:
writing the sub pixels of the input image to one of the first memory and the second memory to store sub pixels for a plurality of successive lines using a write unit, the number of lines being equal to the number of color components in the parallax images included in the input image;
reading the sub pixels as an output image from the other of the second memory and the first memory using a reading unit; and
changing the first memory and the second memory alternately, to write the sub pixels for the plurality of lines of the input image to one of the first memory and the second memory, while reading the sub pixels for the plurality of lines of the output image from the other of the second memory and the first memory.
